(19) United States
(12) Patent Application Publication
(10) Pub. No.: US 2023/0102225 A1
(43) Pub. Date: Mar. 30, 2023

(54) DELIVERY MANAGEMENT SYSTEM

(71) Applicant: TOYOTA JIDOSHA KABUSHIKI KAISHA, Toyota-shi Aichi-ken (JP)

(72) Inventors: Kiyoto Sasaki, Susono-shi Shizuoka-ken (JP); Makoto Kawaharada, Susono-shi Shizuoka-ken (JP); Satoshi Nakamura, Susono-shi Shizuoka-ken (JP); Kenichi Okumura, Gotemba-shi Shizuoka-ken (JP); Naotoshi Kadotani, Sunto-gun Shizuoka-ken (JP)

(73) Assignee: TOYOTA JIDOSHA KABUSHIKI KAISHA, Toyota-shi Aichi-ken (JP)

(21) Appl. No.: 17/950,519

(22) Filed: Sep. 22, 2022

(30) Foreign Application Priority Data
Sep. 27, 2021 (JP) 2021-156828

(51) Int. Cl. G06Q 10/08

(52) U.S. Cl. CPC G06Q 10/083

(57) ABSTRACT

A delivery management system includes: a registration unit configured to register as registrants, persons each being preset or may be set as consignees; an association unit configured to store a second person in association with a first person; a determination unit configured to determine whether or not there are a delivery package scheduled to be delivered to the first person as the consignee and a delivery package scheduled to be delivered to the second person as the consignee; and a delivery information management unit configured to make an adjustment such that a delivery place and a delivery date and time related to the first person who is determined to have the delivery package matches those related to the second person who is determined to have the delivery package, and configured to notify each of the persons of adjustment delivery information.

### CROSS-REFERENCE TO RELATED APPLICATIONS

This application is based upon and claims the benefit of priority of the prior Japanese Patent Application No. 2021-156828, filed on Sep. 27, 2021, the entire contents of which are incorporated herein by reference.

### BACKGROUND

### 1. Technical Field

Embodiments of the present disclosure relate to a delivery management system that manages delivery of a package from a consignor or sender to a consignee or receiver.

### 2. Description of the Related Art

A system of this type manages delivery schedule, for example, such that when a package or cargo is delivered from a consignor to a consignee, the consignee instructs a delivery company about a delivery destination and a delivery date and time in accordance with notified package information, and such that the consignor delivers the package in accordance with the instruction (see International Publication No. WO 02/088008A1 as Patent Literature 1). According to this system, storage, transfer, and delivery of the package can be performed at the convenience of the consignee, which is convenient from the viewpoint of the consignee, and from the viewpoint of the consignor, delivery efficiency could be enhanced.

According to the Patent Literature 1 described above, however, although the convenience and efficiency of the delivery are improved, it is not configured to utilize a delivery service as one of means for suppressing deterioration in physical strength or deterioration in cognitive performance of the elderly. That is, the delivery management system in the Patent Literature 1 cannot lead to the suppression of the deterioration in physical strength or the deterioration in cognitive performance of the elderly because of its technical level; in other words, it cannot contribute to maintain activities of daily living (ADL) or the like of the elderly, which is technically problematic.

### SUMMARY

In view of the problems described above, it is therefore an object of embodiments of the present disclosure to provide a delivery management system that can contribute to the suppression of the deterioration in physical strength or the deterioration in cognitive performance of the elderly.

The above object of embodiments of the present disclosure can be achieved by a delivery management system including a delivery management server that is configured to perform data communication with each of a plurality of terminal apparatuses corresponding to respective one of a plurality of persons, wherein the delivery management server includes: a registration unit configured to register in registration data via the terminal apparatuses, information about registrants each being the person preset or to be set as a consignee; an association unit configured to store at least one second person in association with a first person as an acquaintance among the registrants; a determination unit configured to determine whether or not there are a delivery package scheduled to be delivered to the first person as the consignee and a delivery package scheduled to be delivered to the associated second person as the consignee, by referring to delivery package data in which delivery schedule is set with the registrants as the consignees; and a delivery information management unit configured to make an adjustment such that a delivery place and a delivery date and time related to the first person who is determined to have the delivery package matches those related to the second person who is determined to have the delivery package, and configured to notify via the terminal apparatuses, the first person and the second person of adjustment delivery information respectively, the adjustment delivery information including adjusted delivery place and adjusted delivery date and time.

According to an aspect of the delivery management system in the embodiments of the present disclosure, the determination unit determines whether or not there are both a delivery package for the first person as the consignee and a delivery package for the second person as the consignee, on the basis of information about the consignees and information about acquaintances of the consignees. The delivery information management unit makes an adjustment such that the delivery place and the delivery date and time corresponding to the first person who is determined to have the delivery package matches those corresponding to the second person who is determined to have the delivery package, and notifies each of the persons who are determined to have the delivery packages, of the adjusted delivery place and the adjusted delivery date and time. As a result, for example, if the first and second persons who are elderly persons walk to the notified delivery place (e.g., a community facility, a convenience store, a consolidating place, etc.) on the notified delivery date and time, then, they meet each other at the delivery place. Therefore, in addition to walking as an exercise, they each can have a conversation, exchange information, confirm health maintenance, or the like with his/her acquaintance at the delivery place. Thus, it leads to the suppression of the deterioration in physical strength or the deterioration in cognitive performance of the elderly.

Such effects according to the embodiments of the present disclosure will be more apparent by DETAILED DESCRIPTION OF THE EMBODIMENT described below.

### BRIEF DESCRIPTION OF THE DRAWINGS

FIG. 1 is a block diagram illustrating an example of an overall configuration of a delivery management system according to an embodiment;

FIG. 2A is a block diagram illustrating an example of a hardware configuration of the delivery management server according to the embodiment;

FIG. 2B is a block diagram illustrating an example of a hardware configuration of a terminal apparatus according to the embodiment;

FIG. 3 is a data configuration diagram illustrating an example of a data group that is accessible by the delivery management system according to the embodiment;

FIG. 4 is a flowchart illustrating an example of a process related to management of delivery schedule in the delivery management system according to the embodiment;

FIG. 5 is a diagram illustrating an example of a delivery notification screen according to the embodiment; and

FIG. 6 is a diagram illustrating an example of a reservation notification screen according to the embodiment.

### DETAILED DESCRIPTION OF THE EMBODIMENT

### 1. Overall Configuration of Delivery Management System

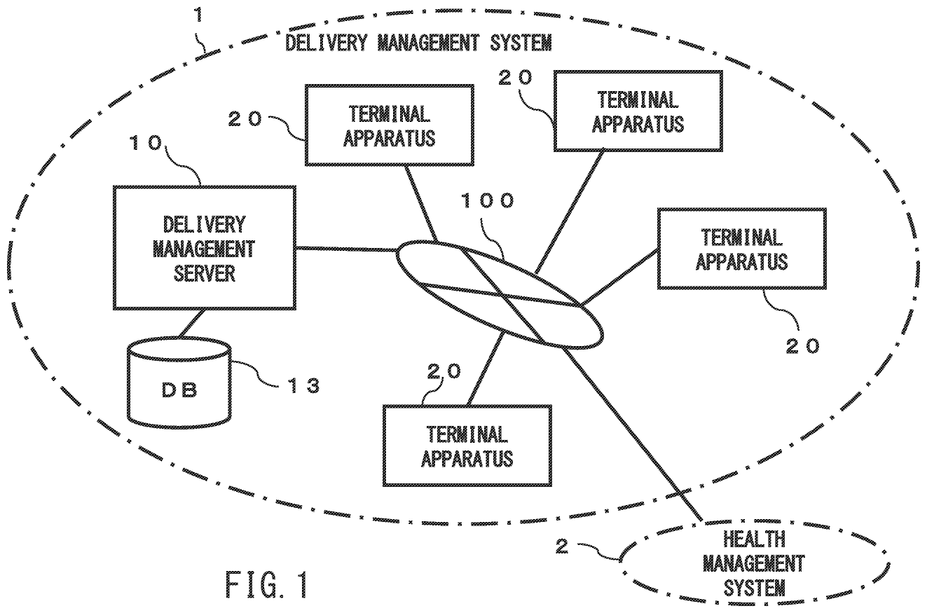

First, an overall configuration of a delivery management system 1 according to an embodiment will be described with reference to FIG. 1. In the delivery management system 1, delivery schedule is adjusted such that acquaintances as consignees can meet at a same delivery place for receiving.

As illustrated in FIG. 1, the delivery management system 1 according to the embodiment may include a delivery management server 10, a database 13 that is accessible by the delivery management server 10, and a plurality of terminal apparatuses 20. The delivery management server 10 and each of the terminal apparatuses 20 are allowed to perform data communication with each other, and the delivery management system 1 may be constructed, for example, on the Internet 100. The terminal apparatus 20 conceptually includes a smartphone, a personal computer, a tablet terminal, or the like, each terminal apparatus 20 corresponding to each of a plurality of persons including the elderly to accept an input operation of each person. On the other hand, the delivery management server 10 may be placed, for example, in a business office of a delivery company or on a cloud, under the control of the delivery company. Although four terminal apparatuses 20 are illustrated in FIG. 1, the number of the terminal apparatuses 20 in the delivery administration system 1 is not limited to this number. The database (DB) 13 may be configured to be accessible to the delivery management server 10 through the Internet 100. On the Internet 100, as illustrated in FIG. 1, an additional system that is accessible by the delivery management server 10, such as, for example, a health management system 2, may also be constructed. The health management system 2 may include one or more health management servers.

Incidentally, the delivery management server 10 and the database 13 illustrated in FIG. 1 are conceptually configurated, and may be physically realized as one apparatus, or may be physically realized by a plurality of apparatuses. For example, any one or more of the terminal apparatuses 20 may work as a part or all of the process and hardware configuration of the delivery management server 10, thereby to realize the delivery management server 10. Alternatively, all of the process and hardware configuration of the delivery management server 10 may be distributed to the terminal apparatuses 20 to realize the delivery management server 10.

### 2. Delivery Management Server Hardware Configuration

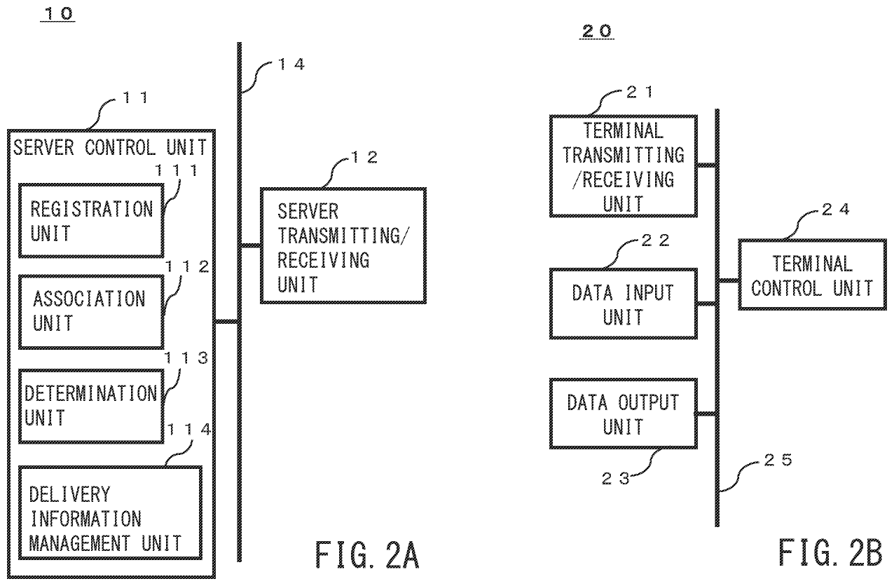

An example of the hardware configuration of the delivery management server 10 will be described with reference to FIG. 2A. Since the delivery management server 10 is a conceptual one as described above, the hardware configuration illustrated in FIG. 2A and its operation may be realized, for example, by a plurality of server apparatuses. Alternatively, a part or all of the hardware configuration and its operation may be distributed and realized on at least a part of the terminal apparatuses 20.

The delivery management server 10 may include, for example, a server control unit 11 and a server transmitting/receiving unit 12. The server control unit 11 and the server transmitting/receiving unit 12 are allowed to perform data communication with each other and may be connected to each other through a data bus 14, for example. Furthermore, the delivery management server 10 may include, for example, a not-illustrated data input/output unit that accepts various operations of a delivery manager and outputs various data to the delivery manager.

For example, the server transmitting/receiving unit 12 transmits and receives various data through an external configuration of the delivery management server 10 (for example, the database 13 and each of the terminal apparatuses 20) and the Internet 100. The server control unit 11 is configured to control each process performed by the delivery management server 10. The server control unit 11 may be configured, for example, as a computer unit including a CPU (Central Processing Unit) and a storage area required for its operation: a RAM (Random Access Memory) and a ROM (Read Only Memory).

For example, the server control unit 11 may read and execute a computer program stored in the ROM. For example, the server control unit 11 may read a computer program stored in a non-volatile recording medium that is readable by a computer, by using a not-illustrated recording medium reading apparatus. The server control unit 11 may read a computer program from a not-illustrated apparatus that is located outside the delivery management server 10 through the Internet 100. The server control unit 11 executes the read computer program. As a result, logical functional blocks for performing an operation to be performed by the delivery management server 10 are realized in the server control unit 11. That is, the server control unit 11 is configured to function as a controller for realizing the logical functional blocks for performing operations to be performed by the delivery management server 10. FIG. 2A illustrates an example of the logical functional blocks realized in the server control unit 11. As illustrated in FIG. 2A, for example, a registration unit 111, an association unit 112, a determination unit 113, and a delivery information management unit 114 may be realized in the server control unit 11. The operation of each of the units 111 to 114 will be described later.

### 3. Data Held by Database

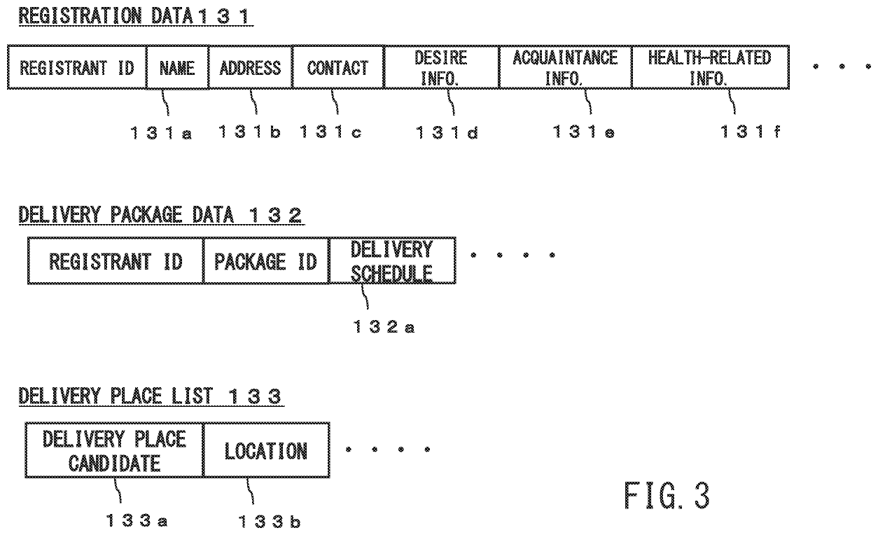

The database 13 holds various data required for various processes performed by the delivery management server 10. The database 13 may store therein, for example, registration data 131, delivery package data 132, and a delivery place list 133, as illustrated in FIG. 3. The registration data 131 includes information about a person who is preset or may be set as a consignee in the delivery management system 1. The registration data 131 may be configured such that information about a registrant is associated with a registrant ID for identifying each person, for example, as illustrated in FIG. 3. The information about the registrant may include, for example, a name 131a, an address 131b, a contact 131c, desire information 131d, acquaintance information 131e, health-related information 131f, and the like. The address 131b may be, for example, a home address or residence of the registrant. The contact 131c may be, for example, a telephone number, a mail address, or the like of the registrant. The desire information 131d is information about the registrant's desire regarding the reception of the package. The desire information 131d may include, for example, a convenient period of time for receiving a package or an inconvenient period of time.

In the acquaintance information 131e, for example, the registrant ID of at least one person specified as an acquaintance by the registrant may be set. The acquaintance information 131e is set, for example, by the association unit 112 of the server control unit 11. The health-related information 131f is obtained, for example, by extracting to store for each registrant, useful information for delivery management within information indicating a health condition of the registrant, from the health management system 2 accessible by the delivery management server 10. The extraction of the health-related information 131f may be performed by the delivery management server 10, for example, every time the health-related information 131f is updated in the health management system 2. Alternatively, the extraction may be performed every time adjustment delivery information described later is created, or may be performed periodically at predetermined intervals. The health-related information 131f may include, for example, vital information such as blood pressure and body temperature of the registrant, objective information about quantity of exercise such as the number of steps, and other points to be considered about the health of the registrant. Such points to be considered may include, for example, information indicating that the registrant has a lack of exercise and is recommended to walk for a long time, information indicating that long-time walking is prohibited due to arthritis and an internal disease, and the like. The points to be considered may also include information that can be determined and set by the server control unit 11 on the basis of the objective information obtained from the health management system 2.

The delivery package data 132 includes delivery schedule for a delivery package scheduled to be delivered to the registrant of the registration data 131 as the consignee. For example, as illustrated in FIG. 3, a package ID for identifying each delivery package, delivery schedule information 132a and the like may be associated with the registrant ID. The delivery schedule information 132a is information about the delivery schedule, and may include, for example, a delivery place, a delivery date and time, a delivery vehicle ID for identifying a delivery vehicle, and the like. The delivery package data 132 is generated before the delivery. The delivery package data 132 may be generated, for example, at each time when the delivery package of any registrant arises. The delivery package data 132 may be generated, for example, when the package is collected or a request is made for the package collection. Alternatively, the delivery package data 132 may be generated on the basis of an input operation performed by the delivery manager or the registrant. When the delivery package data 132 is generated, the delivery schedule information 132a may be blank.

The delivery place list 133 is a list of a delivery place candidate 133a, which is preset as a location that may be determined to be the delivery place. For example, as illustrated in FIG. 3, in the delivery place list 133, the delivery place candidate 133a may be associated with information on the delivery place candidate such as its location 133b and the like. A desirable candidate as the delivery place candidate 133a includes, for example, a community facility, a convenience store, a consolidating place, a park, or the like where the elderly can spend the time to relax and talk.

### 4. Operation of Server Control Unit

Returning to FIG. 2A, the operations of each of the units 111 to 114 implemented by the server control unit 11 will be described. The registration unit 111 may be configured, for example, to register after the delivery package arises, information about a person who is preset as the consignee in the registration data 131, or to register before the delivery package arises, information about a person who may be set as the consignee in the registration data 131. The association unit 112 may be configured to store at least one second person in association with a first person as an acquaintance among a plurality of registrants registered in the registration data 131, wherein the first person is an elderly person and the second person is acquainted with the first person and the second person is an elderly or non-elderly person. In this embodiment, the association unit 112 stores the at least one second person to be associated with the first person as the acquaintance, in the acquaintance information 131e in the registration data 131 regarding the first person. When associating the second person with the first person as the acquaintance, the association unit 112 may, for example, associate ant store the second person in association with the first person as the acquaintance.

The determination unit 113 may be configured to may determine, for example, in a state that the registration is made by the registration unit 111 and the association is performed by the association unit 112 as described above, whether or not there are a package scheduled to be delivered to the first person as the consignee and a package scheduled to be delivered to at least any one of the second persons as the consignee, the second person being associated as the acquaintance, The determination unit 113 may perform the determination with reference to the delivery package data 132.

For example, when it is determined as a result of the determination by the determination unit 113 that the first person and the at least one second person have the packages, the delivery information management unit 114 may be configured to make an adjustment such that the delivery place and the delivery date and time related to the first person who is determined to have the package matches those related to the at least one second person who is determined to have the package. A method of determining the delivery place will be described later. Furthermore, the delivery information management unit 114 may be configured to notify each corresponding person of the adjustment delivery information including the adjusted delivery place and delivery date and time, via the terminal apparatus 20.

### 5. Hardware Configuration of Terminal Apparatus

An example of a basic hardware configuration of the terminal apparatus 20 will be described with reference to FIG. 2B. The terminal apparatus 20 may include, for example, a terminal transmitting/receiving unit 21, a data input unit 22, a data output unit 23, and a terminal control unit 24. The terminal transmitting/receiving unit 21, the data input unit 22, the data output unit 23, and the terminal control unit 24 may be connected to each other to allow data communication, for example, through a data bus 25. The terminal transmitting/receiving unit 21 may be configured, for example, to perform transmission and reception of various data with an external configuration of the terminal apparatus 20, such as the delivery management server 10, through the Internet 100. The data input unit 22 may be configured, for example, to receive data inputs of various data from an operator of the terminal apparatus 20. The data input includes, for example, an input via various input devices such as a keyboard and a mouse, a contact input or a non-contact input to a touch panel, button or the like, an audio input, and the like. The data output unit 23 may be configured, for example, to output various data to the operator of the terminal apparatus 20. The data output includes a screen output, an audio output, etc.

The terminal control unit 24 is configured to control each process in the terminal apparatus 20 by controlling the operations of each of the other units 21, 22, and 23. The terminal control unit 24 may be configured as a computer unit including, for example, a CPU (Central Processing Unit) and a storage area required for its operation: a RAM (Random Access Memory) and a ROM (Read Only Memory). The terminal control unit 24 may function, for example, as a user interface of the delivery management server 10. The terminal control unit 24 may allow the operator to input data and may transmit the input data to the delivery management server 10, for example, in accordance with instructions from the delivery management server 10. Furthermore, the terminal control unit 24 may obtain the data from the delivery management server 10 and output the obtained data to the operator, for example, in accordance with instructions from the delivery management server 10. The terminal control unit 24 may be configured to implement at least a part of the above-described units 111 to 114 of the server control unit 11.

### 6. Processing Performed by Delivery Management System

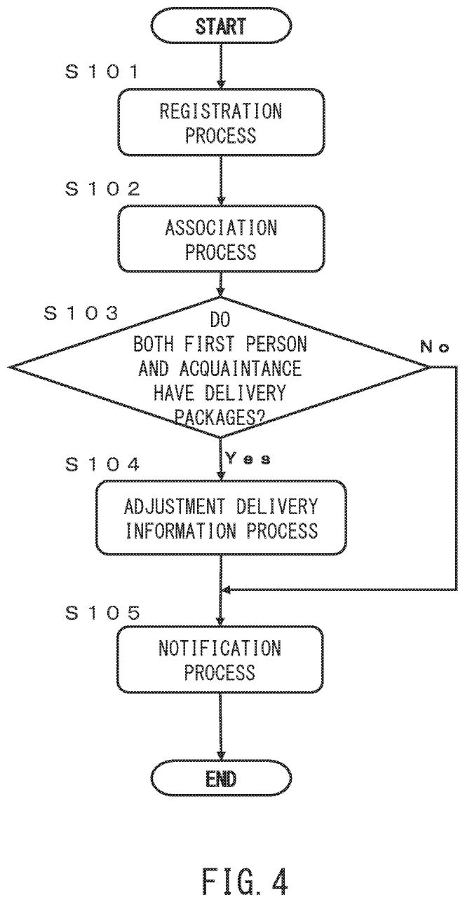

Processes regarding the delivery schedule performed in the delivery management system 1 will be described with reference to a flowchart in FIG. 4, centering on a process performed by the server control unit 11. First, the registration unit 111 performs a registration process (step S101). As the registration process, for example, via the terminal apparatus 20 in accordance with operations of a person who is preset or may be set as the consignee, the registration unit 111 may assign the registrant ID to the person, and may register as the information about the registrant, the information about the person in the registration data 131 in the database 13 (see FIG. 3).

Next, the association unit 112 performs an association process (step S102). In the association process, for example, at least one second person may be associated as the acquaintance with a first person who is one of the registrants in the registration data 131. For example, the association unit 112 may present a list of the registrants in the registration data to the first person, may have the first person select at least one second person whom the first person wishes to register as the acquaintance, and may set the registrant ID of each selected second person in the acquaintance information 131e in the registration data 131 regarding the first person.

For example, the association unit 112 may present to the first person in a selectable manner as the acquaintance, the second person for whom the first person is already set in the acquaintance information 131e as the acquaintance. Alternatively, for example, the association unit 112 may access friend information (including information about a companion and information about a person concerned, etc.) in a not-illustrated SNS (Social Networking System) used by the first person, and may present to the first person in a selectable manner, the registrant who is also registered in the friend information, as the acquaintance of the first person. For example, when the first person is not set in the acquaintance information 131e in the registration data 131 regarding the second person who is selected by the first person as the acquaintance, the association unit 112 may set the first person in the acquaintance information 131e regarding the second person.

Subsequently, the determination unit 113 performs a determination process (step S103). In the determination process, for example, it may be determined whether or not there are both a delivery package scheduled to be delivered to the first person as the consignee and a delivery package scheduled to be delivered to at least any one of the acquaintances of the first person as the consignee. The determination unit 113 may perform the determination, for example, by referring to the delivery package data 132. When at least the registrant ID and the package ID are registered in the delivery package data 132, the determination unit 113 may determine that there is a delivery package scheduled to be delivered to the corresponding registrant as the consignee.

In the step S103, when the determination is negative, that is, when it is not determined that there are both the delivery packages (the step S103: No), for example, the server control unit 11 may end the processing routine. On the other hand, in the step S103, when the determination is affirmative, that is, when it is determined that there are both of the delivery packages (the step S103: Yes), the delivery information management unit 114 may perform an adjustment delivery information process (step S104). As the adjustment delivery information process, the delivery information management unit 114 may make an adjustment such that the delivery place and the delivery date and time related to the first person who is determined to have the delivery package scheduled to be delivered matches those related to the second person who is determined to have the delivery package scheduled to be delivered, and may create the adjustment delivery information including the adjusted delivery place and delivery date and time

With respect to the adjustment of the delivery place, the delivery information management unit 114 may determine the delivery place, for example, on the basis of the addresses of the first and second persons. In addition, with respect to the adjustment of the delivery date and time, the delivery information management unit 114 may make a determination, for example, in accordance with a desired period of time registered in the desire information 131d in the registration data 131. Furthermore, the delivery information management unit 114 may determine the delivery place and the delivery date and time in consideration of the health-related information 131f in the registration data 131. For example, for a person who is recommended to walk for a long time or for a person who exercises less than a predetermined level, the delivery information management unit 114 may determine the delivery place that is far away from the person's home, in comparison with the case of the other person who receives the package at the same time. On the other hand, for a person who is forbitten to walk for a long time or who exercises more than the predetermined level, a location close to the person's home may be determined as the delivery place, in comparison with the case of the other person receiving the package at the same time. Alternatively, the delivery information management unit 114 may determine, as the delivery place, a location near the center point of the addresses of a plurality of persons who receive the packages at the same time. Furthermore, for example, when there is a person who can hardly see clearly in dim light, the delivery information management unit 114 may determine a daytime period as the delivery date and time. As described above, the delivery information management unit 114 may refer to each item of the registration data 131 and/or the delivery place list 133 and incorporate them into an algorithm for the adjustment of the delivery place and the delivery date and time.

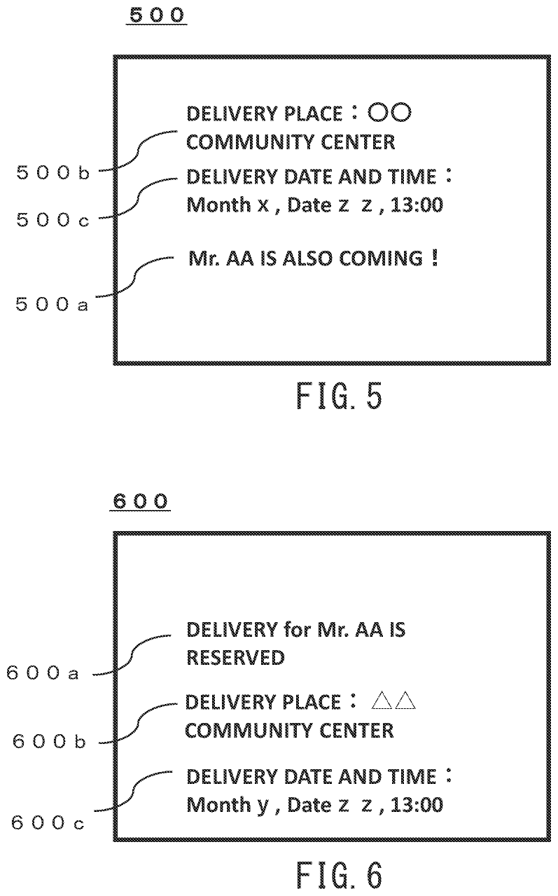

The delivery information management unit 114 performs a notification process after creating the adjustment delivery information (step S105). In the notification process, the delivery information management unit 114 notifies each person for whom the determination is affirmative in the step S103, of the adjustment delivery information. For example, the delivery information management unit 114 may send a delivery notice to the terminal apparatus 20 corresponding to each person for whom the determination is affirmative, and may allow a delivery notification screen 500 illustrated in FIG. 5 to be presented. The delivery notice may include, for example, person information indicating the other person (i.e., acquaintance) to which the same adjustment delivery information is sent, as well as the adjustment delivery information. The delivery notification screen 500 displayed on the basis of the delivery notice may display, as illustrated in FIG. 5, not only a delivery place 500b and a delivery date and time 500c indicated by the adjustment delivery information, but also a name of the acquaintance who is notified of the same adjustment delivery information, i.e., an acquaintance name 500a of the acquaintance who comes to receive the package at the same delivery place and the same date and time. In the example illustrated in FIG. 5, one acquaintance name 500a is displayed, but in a case that there are other people who are notified of the same adjustment delivery information, all the acquaintance names may be displayed.

The delivery information management unit 114 may set the adjustment delivery information in the delivery schedule information 132a in the delivery package data 132 of each person corresponding to the adjustment delivery information, before and after the notification of the adjustment delivery information. Alternatively, the delivery information management unit 114 may set the adjustment delivery information in the delivery schedule information 132a in the delivery package data 132 regarding a person who is approved among people to whom the delivery notification screen 500 is presented. When the delivery schedule information 132a having been already set, the delivery information management unit 114 may change it to the adjustment delivery information. Thus, the adjusted delivery place and delivery date and time are set as the delivery schedule of each person corresponding to the adjustment delivery information.

The determination process in the step S103 may be configured to be performed at high frequencies, regularly or irregularly before the delivery, after the association process of step S102. Alternatively, the determination process in the S103 may be performed at each time when at least the registrant ID and the package ID are registered in the delivery package data 132.

The delivery management system 1 may be further configured as follows. For example, in the database 13, there may be stored group information about a group in association with a particular delivery place, the group information containing, as members thereof, a plurality of persons who are acquaintances among the registrants of the registration data 131. The group may be set and stored, for example, by a registrant's input operation. Furthermore, the delivery information management unit 114 of the server control unit 11 may include a reservation notification unit, wherein the reservation notification unit accepts a delivery reservation for a package to be delivered to the registrant as a consignee, and when such a delivery reservation that the particular delivery place is designated for one member in the group is made, the reservation notification unit notifies the other members in the group that the reservation of the delivery to the particular delivery place is made. The reservation notification unit may send, for example, a delivery reservation notice including the particular delivery place and the delivery date and time, not only to a member for whom the delivery reservation is made, but also to the other members. As illustrated in FIG. 6, the terminal apparatus 20 may display a reservation notification screen 600 showing a member (i.e., Mr. AA) 600a for whom the delivery reservation is made, a delivery place (i.e., the particular delivery place) 600b, and the delivery date and time 600c, on the basis of the information included in the received delivery reservation notice. For example, when the particular delivery place is set in the delivery schedule information 132a in the delivery package data 132, the delivery information management unit 114 may determine that the reservation of the delivery to the particular delivery place is made. The group information may be held in the delivery place list 133 in association with the delivery place candidate 133a as the particular delivery place, for example. Alternatively, the group information may be stored in association with a location that is different from the delivery place candidate 133a as the particular delivery place.

Here, if simpler and less burdensome processes and configurations are adopted, the health management system 2 as illustrated in FIG. 1 is unnecessary. In that case, the health-related information 131f in the registration data 131 illustrated in FIG. 3 is also unnecessary, and it is unnecessary to adjust the delivery place or the like in consideration of the health-related information 131f. Furthermore, one location where the elderly or the like likely gather (e.g., a community center) may be determined in advance as the adjusted delivery place. In this case, the delivery place list 133 is unnecessary, and when the adjustment delivery information is created, the adjustment for matching the delivery places is also unnecessary, and only the adjustment for matching the delivery dates and times is performed. Additionally, the delivery place to be adjusted may be not a building or facility, but a delivery point (or delivery position). In this instance, a mobile social meeting place, such as an autonomous vehicle for MaaS (Mobility as a Service), may be stopped at the adjusted delivery position and may be used as the delivery place. Also in this case, the delivery place list 133 is unnecessary. The autonomous vehicle for MaaS may be used as a consolidating place. Even in the aspect described above, it is possible to have the elderly go out for receiving the package and to allow the acquaintances to meet each other at the delivery place. Therefore, the effects of suppressing the deterioration in physical strength or the deterioration in cognitive performance of the elderly are sufficiently exerted.

According to the configuration of the delivery management system 1, from the viewpoint of enabling the application of this system even when the delivery package needs to be refrigerated or frozen, the delivery vehicle is desirably equipped with a refrigerator. On the other hand, by putting together a plurality of delivery places into one place, a cost spent on the delivery is assumedly reduced in comparison with the normal delivery. Therefore, if the plurality of delivery places in the normal delivery can be put together in one, it is also possible to promote ecology by setting a low delivery charge.

As described in detail, according to the embodiment, if the first person who is for example an elderly person and the second person, an acquaintance of the first person, who is for example an elderly person, go to a local communication facility such as a neighboring convenience store and community center, a fixed delivery place in a building, or a mobile delivery place such as an autonomous vehicle for MaaS, on the delivery date and time, as being guided by the adjustment delivery information notified by the delivery management system 1, then, the acquainted first and second persons who might be, for example, friends or acquaintances meet each other at the delivery place. Therefore, in addition to walking as an exercise, a conversation, exchange information, confirmation of health maintenance, and the like could be actually realized between such persons at the delivery place, which would be hardly performed if no technical measures are taken. Therefore, it is possible to lead to the suppression of the deterioration in physical strength or the deterioration in cognitive performance of the elderly, and to contribute greatly to maintain the ADL or the like of the elderly.

### <Supplementary Notes>

With respect to the embodiment described above, the following Supplementary Notes are further disclosed.

### Supplementary Note 1

A delivery management system described in Supplementary Note 1 is a delivery management system including a delivery management server that is configured to perform data communication with each of a plurality of terminal apparatuses corresponding to respective one of a plurality of persons, wherein the delivery management server includes: a registration unit configured to register in registration data via the terminal apparatuses, information about registrants each being the person preset or to be set as a consignee; an association unit configured to store at least one second person in association with a first person as an acquaintance among the registrants; a determination unit configured to determine whether or not there are a delivery package scheduled to be delivered to the first person as the consignee and a delivery package scheduled to be delivered to the associated second person as the consignee, by referring to delivery package data in which delivery schedule is set with the registrants as the consignees; and a delivery information management unit configured to make an adjustment such that a delivery place and a delivery date and time related to the first person who is determined to have the delivery package matches those related to the second person who is determined to have the delivery package, and configured to notify via the terminal apparatuses, the first person and the second person of adjustment delivery information respectively, the adjustment delivery information including adjusted delivery place and adjusted delivery date and time.

According to the delivery management system described in Supplementary Note 1, the registration unit registers therein a person who is preset as the consignee after the delivery package arises, or registers therein a person who may be set as the consignee before the delivery package arises. Here, for example, in the delivery management system, among a plurality of persons registered in this manner, the second person who is acquainted with the first person is stored in association with the first person as the acquaintance of the first person. In such a registration state and a storage state, the determination unit determines whether or not there are both a delivery package scheduled to be delivered to the first person as the consignee and a delivery package scheduled to be delivered to the second person as the consignee, by referring to the delivery package data in which the delivery schedule is set with the registrants as the consignees. As the timing for performing such a determination, for example, the determination may be performed when the delivery package for the first person as the consignee is collected or a request is made for the package collection, or the determination may be performed at high frequencies, regularly or irregularly, before the delivery. When both the first and second persons have the delivery packages, the delivery information management unit creates the adjustment delivery information so as to match the respective delivery places and delivery dates and times related to the delivery packages of the persons, and notifies each of the persons of the adjustment delivery information. As a result thereof, if the first person who is, for example, an elderly person and the second person who is acquainted with the first person and who is, for example an elderly person walk to the notified delivery place on the notified delivery date and time as being guided by the adjustment delivery information notified by the delivery management system, then, the acquainted first and second persons who are, for example, friends or acquaintances meet each other at the delivery place. Therefore, in addition to the walking as an exercise, a conversation, exchange information, confirmation of health maintenance, and the like could be actually realized between such persons at the delivery place, which may be hardly performed if no technical measures are taken. Therefore, it is possible to lead to the suppression of the deterioration in physical strength or the deterioration in cognitive performance of the elderly, and it is possible to contribute greatly to maintain the ADL of the elderly and the like. Incidentally, the delivery place may be, for example, one of facilities where the elderly likely gather (e.g., a community center, a consolidating place, a park, etc.). Alternatively, it may be, for example, a position where a mobile delivery place such as an autonomous vehicle for MaaS is stopped.

### Supplementary Note 2

A delivery management system described in Supplementary Note 2 is the delivery management system described in Supplementary Note 1, wherein the delivery information management unit is configured to give notice of person information via the terminal apparatuses together with the adjustment delivery information such that the first person and the second person who are notified of the adjustment delivery information same as each other, can recognize each other.

According to the delivery management system described in Supplementary Note 2, the person information is also sent together with the adjustment delivery information such that the first person and the second person who are notified of the same adjustment delivery information can recognize each other. This makes it possible to notify each of the persons corresponding to the same adjustment delivery information, of the acquaintance they can meet at the delivery place, thereby increasing each person's desire to go out.

### Supplementary Note 3

A delivery management system described in Supplementary Note 3 is the delivery management system described in Supplementary Note 1, wherein the delivery management server is accessible to another system in which a health status of each of the first person and the second person is sensed or in which data about the health status is registered, and the delivery information management unit is configured to adjust at least one of the delivery place and the delivery date and time in consideration of the health status.

According to the delivery management system described in Supplementary Note 3, it is possible to determine the delivery place in consideration of the health status of each individual, for example, by securing quantity of exercise with walking or by not allowing unreasonable exercise. Therefore, it is possible to create the adjustment delivery information that is more or less appropriate for the health status of each registrant who is a user or the consignee of the delivery. Therefore, it can directly contribute to the suppression of the deterioration in physical strength or the deterioration in cognitive performance of the elderly.

### Supplementary Note 4

A delivery management system described in Supplementary Note 4 is the delivery management system described in Supplementary Note 1, wherein the delivery information management unit is configured to determine a vicinity of a center point of homes of the first person and the second person, to be the delivery place to be matched.

According to the delivery management system described in Supplementary Note 4, it is possible to use the delivery place that is not far from or that is close to both the first person and the second person, thereby keeping a balance between the two.

### Supplementary Note 5

A delivery management system described in Supplementary Note 5 is the delivery management system described in Supplementary Note 1, wherein the association unit is configured to store group information about a group containing, as members, the first person and the at least one second person, in association with a particular delivery place, and the delivery information management unit is further configured to include a reservation notification unit, wherein when a delivery reservation of delivery to the particular delivery place is made for one member in the group as the consignee, the reservation notification unit notifies other members in the group that the delivery reservation is made.

According to the delivery management system described in Supplementary Note 5, in a group associated with a particular delivery place, when a delivery reservation of delivery to the particular delivery place is made for one of a plurality of members of the group, other members in the group are notified that the delivery reservation is made. That is, the other members may be notified that the delivery reservation of delivery to the particular delivery place is made. If such notification is set as a delivery reservation notice indicating, for example, a reserved delivery date and time and the particular delivery place, the members who receive such delivery reservation notice may know where and when to meet the member who made the delivery reservation. Furthermore, for example, the members who receive the delivery reservation notice can perform setting such that their own delivery reservations match the delivery place and the delivery date indicated by the delivery reservation notice.

The present disclosure may be embodied in other specific forms without departing from the spirit or characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. A delivery management system comprising a delivery management server that is configured to perform data communication with each of a plurality of terminal apparatuses corresponding to respective one of a plurality of persons, wherein the delivery management server includes:
a registration unit configured to register in registration data via the terminal apparatuses, information about registrants each being the person preset or to be set as a consignee;
an association unit configured to store at least one second person in association with a first person as an acquaintance among the registrants;
a determination unit configured to determine whether or not there are a delivery package scheduled to be delivered to the first person as the consignee and a delivery package scheduled to be delivered to the associated second person as the consignee, by referring to delivery package data in which delivery schedule is set with the registrants as the consignees; and
a delivery information management unit configured to make an adjustment such that a delivery place and a delivery date and time related to the first person who is determined to have the delivery package matches those related to the second person who is determined to have the delivery package, and configured to notify via the terminal apparatuses, the first person and the second person of adjustment delivery information respectively, the adjustment delivery information including adjusted delivery place and adjusted delivery date and time.

2. The delivery management system according to claim 1, wherein the delivery information management unit is configured to give notice of person information via the terminal apparatuses together with the adjustment delivery information such that the first person and the second person who are notified of the adjustment delivery information same as each other, can recognize each other.

3. The delivery management system according to claim 1, wherein
the delivery management server is accessible to another system in which a health status of each of the first person and the second person is sensed or in which data about the health status is registered, and
the delivery information management unit is configured to adjust at least one of the delivery place and the delivery date and time in consideration of the health status.

4. The delivery management system according to claim 1, wherein the delivery information management unit is configured to determine a vicinity of a center point of homes of the first person and the second person, to be the delivery place to be matched.

5. The delivery management system according to claim 1, wherein
the association unit is configured to store group information about a group containing, as members, the first person and the at least one second person, in association with a particular delivery place, and
the delivery information management unit is further configured to include a reservation notification unit, wherein when a delivery reservation of delivery to the particular delivery place is made for one member in the group as the consignee, the reservation notification unit notifies other members in the group that the delivery reservation is made.
